(19) United States
(12) Patent Application Publication
(10) Pub. No.: US 2003/0046783 A1
(43) Pub. Date: Mar. 13, 2003

(54) Polyvinyl acetate sponge and method for producing same

(76) Inventors: Guangshun Chen, Glendale, AZ (US); Xingbo Yang, Phoenix, AZ (US)

Correspondence Address: SNELL & WILMER, ONE ARIZONA CENTER, 400 EAST VAN BUREN, PHOENIX, AZ, 850040001

(21) Appl. No.: 09/950,111

(22) Filed: Sep. 10, 2001

(51) Int. Cl. B32B 3/26

(52) U.S. Cl. 15/244.4; 428/305.5; 428/306.6

(57) ABSTRACT

The present invention relates generally to a polyvinyl acetate (PVA) sponge. More specifically, a PVA sponge according to the present invention has certain improved physical characteristics, such as uniform pore size, a microscopically rough surface, and/or a neutral surface charge. Certain characteristics may be achieved by a variety of methods in which pore-forming chemicals are dissolved into a PVA solution, so that no solid residues remain in the pores of a PVA sponge after production. Neutral surface charge of a PVA sponge may be achieved by adding a charge modifying agent during the sponge making process.

### FIELD OF INVENTION

The present invention generally relates to a polyvinyl acetate (“PVA”) sponge and method for producing same. More specifically, the present invention provides a PVA sponge with unique physical properties for improved cleaning.

### BACKGROUND OF THE INVENTION

Many industries currently use PVA sponges to clean finished, polished surfaces. For example, semiconductor wafers require careful cleaning after chemical-mechanical polishing (“CMP”), to remove all remaining particles of slurry and other residue from the polishing process. Similarly, memory disks and video display screens also require post-production cleaning, and manufacturers often use PVA sponges to do so. These sponges work well for removing larger particles from various finished surfaces, but are far less effective at cleaning ultra-fine, microscopic particles, such as trace metals and mobile ions. Such microscopic particles often cling mechanically or chemically to microscopic irregularities in a highly-polished surface. Since the ultra-fine particles often possess an electric charge, they may also adhere to polished surfaces by electrostatic, or Van der Walls, forces. Conventional PVA sponges typically cannot remove microscopic particles that cling chemically or electrostatically to polished surfaces in this way. Despite their small size, microscopic contaminants can cause functional problems in products which need to be absolutely clean. For example, microscopic particles on a semiconductor wafer may make the wafer unusable for the production of semiconductor devices.

Certain physical characteristics of a PVA sponge determine whether it will clean surfaces with optimal efficiency. These characteristics include softness, porosity, elasticity, pore size and uniformity, liquid holding capacity and liquid absorption rate. One type of ideal PVA sponge, for example, might be relatively soft, highly porous and elastic, with high liquid holding capacity and fast liquid absorption rate, and with uniform, small pores. It might also be beneficial to have a PVA sponge with a relatively “rough” surface texture, at the microscopic level. A microscopically rough texture would allow a PVA sponge to clean ultra-fine particles from microscopic crevices and cavities in finished surfaces.

Another physical characteristic of a PVA sponge which may be controlled in the production process is the surface charge of the sponge. Current PVA sponges typically have a slightly negative surface charge, which is inherent in the sponges simply from the way they are made. For example, a typical sponge may have a charge, or “zeta potential,” of −5 millivolts at a pH of around 3. Additionally, the surface charge of a typical sponge usually decreases as the pH of the solution in which it is submerged increases. For example, if a typical sponge is submerged in a bath with a pH of around 8 or 9, it will usually acquire a zeta potential of around −20 millivolts. In some circumstances, it may be desirable to have a PVA sponge that has a neutral surface charge across a wide range of pH conditions. In post-CMP cleaning of semiconductor wafers, for example, many of the residual particles have a positive charge. A typical sponge (with a negative surface charge) will attract these particles and, after cleaning the wafer, the particles will still adhere to the sponge, making it hard to clean the sponge so that it can be used again. Over time, particles accumulate on the typical sponge and eventually make the sponge useless as a cleaning device. A PVA sponge with a neutral surface charge over a range of pH (such as a charge of approximately zero over a pH range of 2 through 11) may clean a surface just as well as a conventional sponge, but will not collect charged particles on it surface. Thus, a neutral sponge would be easier to clean and would have a longer useful life.

Typically, PVA sponges are produced by reacting polyvinyl alcohol with a cross-linking agent in the presence of an acid catalyst. A cross-linking agent may be an aldehyde, a poly basic acid, a ketone or any other molecule suitable for cross-linking polyvinyl alcohol. The acid catalyst typically used is sulfuric acid. Cross-linking refers to the formation of acetate bonds between adjacent hydroxyl groups in different molecules, or in the same polyvinyl alcohol molecule, in three dimensions. The reaction of polyvinyl alcohol with cross-linking agent and acid catalyst produces polyvinyl acetate, which is then cured to form a PVA sponge. In prior art sponge-making techniques, sponge pores are typically generated before the cross-linking process. Unfortunately, these methods often produce sponges with sub-optimal physical properties. For example, pore sizes are typically not uniform. Also, because surfactant molecules sometimes wrap around PVA molecules, cross-linking between the PVA molecules is decreased, resulting in a weakened sponge matrix and a sponge that is too soft and not sufficiently elastic. Prior art techniques also leave a smooth skin on the surface of a PVA sponge, which reduces the sponge's effectiveness for scrubbing/cleaning. Another problem with conventional methods is that surfactant residues remain in some pores after production and are difficult to wash out of the sponge. Additionally, due to the weakened sponge matrix described above, conventional PVA sponges typically have slow liquid-absorption swelling times and are not very durable. Finally, as mentioned above, currently available PVA sponges typically have a slightly negative surface charge, which becomes more negative as pH conditions increase.

Thus, a need exists for a durable PVA sponge with uniform pore size, high porosity, good elasticity, fast swelling and liquid absorption ability, and high liquid holding capacity. A need also exists for a PVA sponge with a microscopically rough surface, which will allow the sponge to reach into cavities on the substrate surface to remove particles. Additionally, a need exists for a PVA sponge with a neutral surface charge, for improved cleaning and increased sponge longevity.

### SUMMARY OF THE INVENTION

In accordance with various aspects of the present invention, a PVA sponge is produced using a chemical leaching method. Leaching chemicals (also called “pore-forming agents”) are mixed into polyvinyl alcohol solution before curing and, thus, before cross-linking of PVA molecules is complete. They vaporize or swell during curing, to form pores, and then dissolve completely, so that no solid residues remain in the pores after production. Such pore-forming agents may include, but are not limited to, treated starches, cellulose and low boiling point liquids, such as certain alcohols and ethers.

According to one embodiment of the present invention, a PVA sponge may be produced by first combining an amount of pore-forming agent and an amount of polyvinyl alcohol solution to create a first mixture. Then, an amount of a cross-linking agent is added to the first mixture to create a second mixture and an amount of acid is added to the second mixture to create a third mixture. The third mixture is then formed into a desired configuration and cured to produce a PVA sponge. In one embodiment, the third mixture is formed by pouring it into a mold and is cured by heating in an oven or water bath. After production, a PVA sponge may be washed to remove residues.

The foregoing example describes one embodiment of a method according to the present invention for making a PVA sponge. It will be recognized by those skilled in the art that any number of suitable pore-forming agents, cross-linking agents, and acids may be used, various combinations of amounts of chemicals may be used, different types and sizes of molds may be used, different curing methods may be employed and the like, while still producing a PVA sponge according to the present invention.

### BRIEF DESCRIPTION OF THE DRAWINGS

Additional aspects of the present invention will become evident upon reviewing the non-limiting embodiments described in the specification and the claims taken in conjunction with the accompanying figures, wherein like numerals designate like elements, and:

FIGS. 1a and 1b are end-on and longitudinal views of a cylindrical PVA sponge, made according to one embodiment of the present invention; and

FIG. 2 is an oblique view of a flat PVA sponge, made according to one embodiment of the present invention.

FIG. 3 is a graph showing charges of a PVA sponge according to one embodiment of the present invention and a conventional PVA sponge, at different pH levels.

### DETAILED DESCRIPTION OF EXEMPLARY EMBODIMENTS

The following descriptions are of exemplary embodiments of the invention only, and are not intended to limit the scope, applicability, or configuration of the invention in any way. Rather, the following description is intended to provide convenient illustrations for implementing different embodiments of the invention. As will become apparent, various changes may be made in the function and arrangement of the elements described in these embodiments without departing from the spirit and scope of the invention. For example, various changes may be made in the design and arrangement of the elements described in the preferred embodiments, without departing from the scope of the invention as set forth in the appended claims.

According to one embodiment of the present invention, a PVA sponge is produced by reacting polyvinyl alcohol with a cross-linking agent in the presence of an acid catalyst. A cross-linking agent may be an aldehyde, a poly basic acid, a ketone or any other molecule suitable for cross-linking polyvinyl alcohol. Examples of acid catalysts include, but are not limited to sulfuric acid. Cross-linking refers to the formation of acetate bonds between adjacent hydroxyl groups in different molecules, or in the same polyvinyl alcohol molecule, in three dimensions. The reaction of polyvinyl alcohol with cross-linking agent and acid catalyst produces polyvinyl acetate (“PVA”), which can then be cured to form a PVA sponge. In prior art PVA sponge-making techniques, pores are generated before the cross-linking process. As described above, these conventional methods produce sponges with non-uniform pore sizes, trapped surfactant particles, a smooth skin on the sponge surface, a weakened sponge matrix and various other disadvantageous characteristics.

In accordance with one embodiment of the present invention, a PVA sponge is produced using a chemical leaching method. By this process, pore-forming agents, in the form of leaching chemicals, are mixed into a polyvinyl alcohol solution before cross-linking. Examples of pore-forming agents include, but are not limited to, certain low boiling point alcohols and ethers, various treated starches, cellulose and other fine chemical particles which, during a curing process, will swell in size or generate gases and then dissolve into liquid, leaving pores in a PVA sponge.

Because the pore-forming agents dissolve completely during the curing process, no solid residues remain in the sponge's pores after production.

In one embodiment of the present invention, a liquid mixture of polyvinyl alcohol, aldehyde, acid catalyst, and pore-forming agent are poured into a mold and cured for 4-20 hours in an oven at 40-70° C. After curing, a formed PVA sponge is removed from the mold and washed. A PVA sponge made according to the present invention can be made in molds of various sizes and shapes and/or can be cut into various sizes and shapes, depending on the size and shape needed. The physical properties of a PVA sponge made according to the present invention, such as porosity, elasticity and pore size, can be engineered by adjusting various aspects of the process. For example, the amount of polyvinyl alcohol, the amount of pore-forming agent, the concentrations of aldehyde and acid, and/or the curing temperature may be adjusted. Generally, if more pore-forming agent is added to the liquid mixture or the liquid mixture is cured at higher temperatures, a PVA sponge will have higher porosity and a larger pore size.

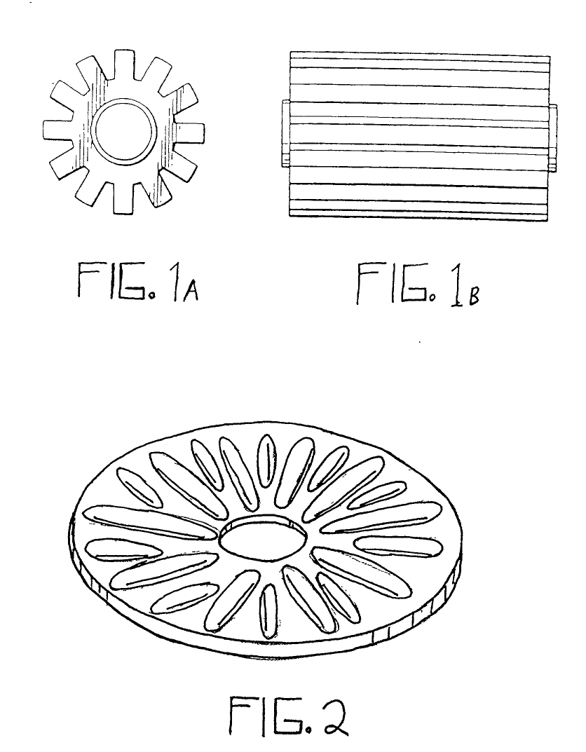

FIGS. 1 and 2 show PVA sponges according to two embodiments of the present invention. It will be understood by those skilled in the art that a PVA sponge according to the present invention may be configured in any shape to conveniently clean any surface. Therefore, the sponges shown in FIGS. 1 and 2 are not limiting in any respect, but are merely included for illustrative purposes.

In yet another embodiment of the present invention, a charge-modifying agent may be added to the solution of polyvinyl alcohol, cross-linking agent, acid catalyst and pore-forming agent, to infuse the resulting PVA sponge with a neutral charge. Examples of charge-modifying agents used in this process may include, but are not limited to polyamines, aliphatic amines and aromatic amines. These agents contain primary, secondary, tertiary or quaternary amine groups, which bond to the PVA matrix, adsorb protons and neutralize the surface charge of a PVA sponge.

Using this method, a PVA sponge according to the present invention may be produced with a surface charge (or “zeta potential”) that closely approximates zero within the pH range of 3 through 11. A PVA sponge that retains a neutral charge over a wide range of pH is advantageous for cleaning certain surfaces and because it can be more easily cleaned, since it does not retain particles via electrostatic forces.

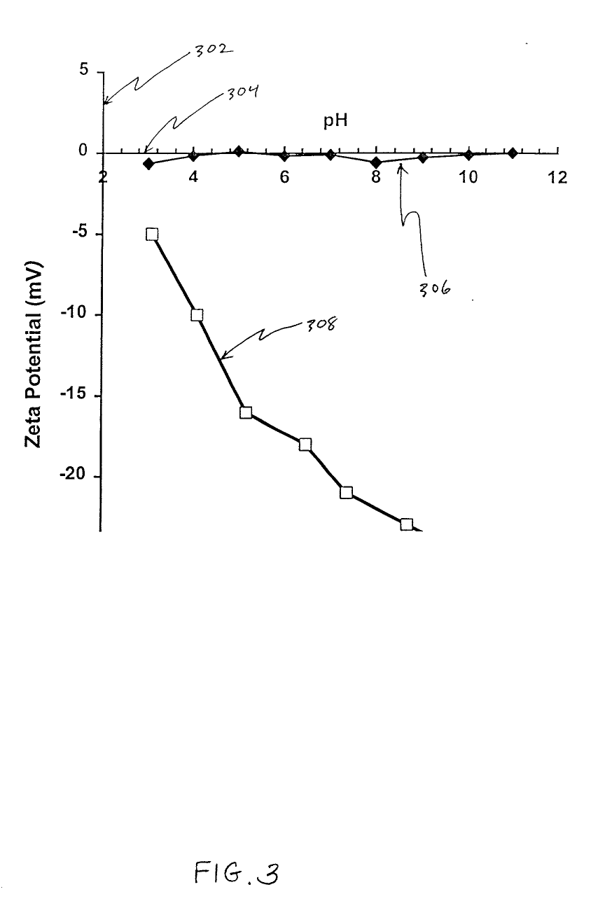

With reference to FIG. 3, the surface charges of two PVA sponges are shown at different pH levels. The y axis 302 represents charge and the x axis 304 represents pH. The surface charges of a PVA sponge according to one embodiment of the invention 306 are very close to neutral throughout the range of pH from 3 to 11. In contrast, the surface charges of a conventional PVA sponge 308 are −5 mV at pH of 3 and decrease to less than −20 mV at pH 9.

Examples of methods for producing a PVA sponge according to the present invention include:

### EXAMPLE 1

### Treated Starch as Pore-Forming Agent

With the aid of appropriate measuring devices, approximately 50 grams of treated potato starch (particle size<10 microns) were added to approximately 1000 ml of polyvinyl alcohol solution in a plastic container, with constant mechanical stirring. Polyvinyl alcohol solution was comprised of 12% by weight of polyvinyl alcohol and 88% by weight of D1 water. Approximately 125 ml of aldehyde solution and approximately 125 ml sulfuric acid were then added, with continuous stirring. Aldehyde concentrations were approximately 37% by weight and acid concentrations were approximately 40% by weight. The solution was then poured into a mold and cured in an oven at 60° C. for approximately 10 hours. During curing, the treated potato starch swelled and finally dissolved into solution so that pores were generated.

After curing, the sponge was removed from the mold and washed, using a mechanical extraction process. This process involved soaking the PVA sponge in DI water and repeatedly squeezing, releasing and spinning the PVA sponge. In that way, cations, anions and other residues were washed out. Then the sponge was washed with a detergent that contained an amine group, using the same process of squeezing, releasing and spinning. Finally, the sponge was rinsed with D1 water and spun, to remove some amount of water from the sponge. The wet sponge was packed in the polycarbonate bags and sterilized in gamma radiation.

The pore size and porosity of the sponges made by this process were between 60 and 100 microns and between 80 and over 85, respectively. Other physical properties may also be controlled.

Although the above Example 1 describes specific amounts of components used to produce a PVA sponge, it will be understood that slight variations in amounts of components may be used, without changing the overall result. For example, approximately 30-200 grams of treated potato starch may be added to approximately 1000 ml of polyvinyl alcohol solution. Then, approximately 80-200 ml of aldehyde solution and approximately 80-150 ml of acid may be added. The resulting solution may be poured into any of a variety of different sizes and shapes of molds and then may be cured in either an oven or a water bath at between 40° C. and 70° C. for approximately 4-20 hours. After curing, a PVA sponge may be adequately cleaned by a variety of washing methods and may be cut, if desired, to conform the sponge to a certain size. The pore size and porosity of the sponges made by this process may be engineered to between 20 and 150 microns and between 60% and over 90%, respectively. Other physical properties may also be controlled.

### EXAMPLE 2

### Cellulose as Pore-Forming Agent

With the aid of appropriate measuring devices, approximately 30 grams of cellulose (particle size<10 microns) were added to approximately 1000 ml of polyvinyl alcohol solution (10% by weight) in a plastic container, with constant mechanical stirring. Approximately 110 ml of aldehyde solution and approximately 90 ml sulfuric acid were then added, with continuous stirring. Aldehyde concentrations were approximately 37% by weight and acid concentrations were approximately 40% by weight. The solution was then poured into a mold and cured in an oven at 60 C. for approximately 10 hours. During curing, the cellulose swelled and finally dissolved into solution so that the pores were generated. After curing, the PVA sponge was removed from the mold and residues, including acid, aldehyde and dissolved cellulose, were washed out of the sponge in a mechanical extraction process as described in Example 1. The pore size and porosity of the sponge made by this process were between 100 and 150 microns and between 80 and 90, respectively. Other physical properties may also be controlled.

Although the above Example 2 describes specific amounts of components used to produce a PVA sponge, it will be understood that slight variations in amounts of components may be used, without changing the overall result. For example, approximately 10-100 grams of cellulose may be added to approximately 1000 ml of polyvinyl alcohol solution. Then, approximately 80-150 of aldehyde solution and approximately 60-130 ml of sulfuric acid may be added. The resulting solution may be poured into any of a variety of different sizes and shapes of molds and then may be cured in either an oven or a water bath at between 40 C. and 70 C. for approximately 4-20 hours. After curing, a PVA sponge may be adequately cleaned by a variety of washing methods and may be cut, if desired, to conform the sponge to a certain size. The pore size and porosity of the sponges made by this process may be engineered to between 60 and 150 microns and between 70% and over 90%, respectively. Other physical properties may also be controlled.

### EXAMPLE 3

### Neutral Surface Charge PVA Sponge

With the aid of appropriate measuring devices, approximately 50 grams of treated potato starch (particle size <10 microns) were added to approximately 1000 ml of polyvinyl alcohol solution in a plastic container, with constant mechanical stirring. Polyvinyl alcohol solution was comprised of 12% by weight of polyvinyl alcohol and 88% by weight of DI water. Approximately 0.5 ml of polyamine solution, and then 125 ml of aldehyde solution and approximately 125 ml sulfuric acid were added, with continuous stirring. Polyamine concentrations were approximately 50% by weight, aldehyde concentrations were approximately 37% by weight and acid concentrations were approximately 40% by weight. The solution was then poured into a mold and cured in an oven at 60 C. for approximately 10 hours. During curing, the treated potato starch swelled and finally dissolved into solution so that pores were generated, and the polyamine molecules were bonded to PVA matrix, resulting in a neutralized surface charge of the PVA sponge without pore size reduction or pore blockage. After curing, the PVA sponge was removed from the mold and residues, including acid, aldehyde, polyamine and dissolved starch, were washed out of the sponge in a mechanical extraction process as described in Example 1. The pore size and porosity of the sponge made by this process were between 60 and 100 microns and between 80 and 85, respectively. The zeta-potentials of the sponge made by this process were close to zero at pH range from 3 to 11. As described above, this charge/pH relationship is represented, and contrasted to a conventional PVA sponge, in FIG. 3. Because these PVA sponges with neutral surface charge did not attract particles via electrostatic attraction forces, the sponges were cleaner, after use and washing, than the sponges made by other processes. Other physical properties may also be controlled.

Although the above Example 3 describes specific amounts of components used to produce a PVA sponge with neutralized surface charge, it will be understood that slight variations in amounts of components may be used, without changing the overall result. For example, approximately 0.2-1 ml of polyamine solution, 30-200 grams of treated potato starch or 10-100 grams of cellulose may be added to approximately 1000 ml of polyvinyl alcohol solution. Then, approximately 80-150 of aldehyde solution and approximately 60-130 ml of sulfuric acid may be added. The resulting solution may be poured into any of a variety of different sizes and shapes of molds and then may be cured in either an oven or a water bath at between 40 C. and 70 C. for approximately 4-20 hours. After curing, a PVA sponge may be adequately cleaned by a variety of washing methods and may be cut, if desired, to conform the sponge to a certain size. The pore size and porosity of the sponges made by this process may be engineered to between 60 to 150 microns and between 70% and over 90%, respectively. The zeta-potentials of the PVA sponges made by this process may be controlled to close zero. The sponges made in this process were cleaner than the sponges made by other processes. Other physical properties may also be controlled.

Lastly, as mentioned above, various principles of the invention have been described only as illustrative embodiments, and many combinations and modifications of the above-described structures, arrangements, proportions, elements, materials and components may be used in the practice of the invention. For example, methods and apparatuses not specifically described may be varied and particularly adapted for a specific environment and operating requirement without departing from those principles.

We claim:

1. A polyvinyl acetate (PVA) sponge, comprising:
a sponge matrix with pores of approximately the same size on a microscopic level; and
a sponge surface with a microscopically rough texture; said sponge matrix and said sponge surface produced by leaching at least one pore-forming chemical into a solution comprising polyvinyl alcohol solution, a cross-linking agent and an acid.

2. The PVA sponge of claim 1, wherein said sponge surface has a neutral charge.

3. The PVA sponge of claim 1, wherein said at least one pore-forming chemical is treated starch.

4. The PVA sponge of claim 1, wherein said at least one pore-forming chemical is cellulose.

5. The PVA sponge of claim 1, wherein said at least one pore-forming chemical is an organic liquid with a low boiling point.

6. The PVA sponge of claim 1, wherein said polyvinyl alcohol solution comprises a solution of polyvinyl alcohol and water.

7. The PVA sponge of claim 1, wherein said cross-linking agent is an aldehyde.

8. The PVA sponge of claim 1, wherein said cross-linking agent is a poly basic acid.

9. The PVA sponge of claim 1, wherein said cross-linking agent is a ketone.

10. The PVA sponge of claim 1, wherein said acid is sulfuric acid.

11. A method for producing a PVA sponge, comprising:
combining an amount of pore-forming agent and an amount of polyvinyl alcohol solution to create a first mixture;
adding an amount of a cross-linking agent to said first mixture to create a second mixture;
adding an amount of an acid to said second mixture to create a third mixture;
forming said third mixture into a desired configuration; and
curing said formed mixture to produce the PVA sponge.

12. The method of claim 11, further comprising adding a charge modifying agent to said first mixture, along with said cross-linking agent, to create said second mixture.

13. The method of claim 12, wherein said charge modifying agent is one of the group of polyamines, aliphatic amines and aromatic amines.

14. The method of claim 10, wherein said pore-forming agent is treated starch, said amount of pore-forming agent is about 30-200 grams and said amount of polyvinyl alcohol solution is about 1000 ml.

15. The method of claim 11, wherein said polyvinyl alcohol solution comprises a solution of polyvinyl alcohol and water.

16. The method of claim 11, wherein said cross-linking agent is an aldehyde.

17. The method of claim 11, wherein said cross-linking agent is a poly basic acid.

18. The method of claim 11, wherein said cross-linking agent is a ketone.

19. The method of claim 11, wherein said cross-linking agent is an aldehyde and said amount of cross-linking agent is about 80-150 ml per 1000 ml PVA solution.

20. The method of claim 11, wherein said acid is sulfuric acid.

21. The method of claim 11, wherein said acid is sulfuric acid and said amount of acid is about 50-120 ml.

22. The method of claim 11, wherein said forming step includes pouring said third mixture into a mold.

23. The method of claim 11, wherein said curing step includes heating said third mixture in an oven for about 4-20 hours, said oven being heated to about 40-70° C.

24. The method of claim 11, wherein said curing step includes heating said third mixture in a water bath for about 4-20 hours, said water bath heated to about 40-70° C.

25. The method of claim 11, further comprising the step of washing said PVA sponge.
